(19) United States
(12) Patent Application Publication
(10) Pub. No.: US 2026/0189932 A1
(43) Pub. Date: Jul. 2, 2026

(54) DETECTING CONFLICTS BETWEEN APPLICATIONS

(71) Applicant: Telefonaktiebolaget LM Ericsson (PUBL), Stockholm (SE)

(72) Inventors: Rerngvit YANGGRATOKE, Järfälla (SE); Farnaz MORADI, Bromma (SE); Andreas JOHNSSON, Uppsala (SE)

(21) Appl. No.: 18/868,325

(22) PCT Filed: May 25, 2022
(86) PCT No.: PCT/SE2022/050513

§ 371 Date: Nov. 22, 2024

(51) Int. Cl. H04W 24/02; H04W 24/08

(52) U.S. Cl. CPC H04W 24/02; H04W 24/08

(57) ABSTRACT

There is provided a method of a device (10, 200) of detecting conflicts between applications being executed in an environment, and a device (10, 200) performing the method. A computer program and computer program product are also disclosed. The method comprises identifying (S101) a plurality of applications being executed in said environment, determining (S102) at least one performance property being affected by each of the identified applications being executed in said environment, determining (S103) whether or not at least two of the identified applications have a conflicting effect on the determined at least one performance property upon being executed in said environment, and if so determining (S104) whether or not a metric indicating degree of conflict between said at least two of the identified applications complies with a conflict severity criteria, and if so detecting (S105) a conflict between the at least two applications being executed in said environment.

### TECHNICAL FIELD

The present disclosure relates to a method of a device of detecting conflicts between applications being executed in an environment, and a device performing the method. A computer program and computer program product are also disclosed.

### BACKGROUND

Recent trends enabling intelligent network and service management in the use of data-driven models trained using machine learning (ML) and observations from network components. The ability to learn models from observations simplify management tasks such as orchestration, scheduling, proactive service assurance, and root cause analysis.

Future alternative of deployment for the above data-driven models will come from multiple vendors, i.e., Open Radio Access Network (O-RAN). The ML deployments are applications executed in RAN intelligent controllers (RICs) which automate a control loop for a network element or function inside a telecommunication network.

The RICs can be broadly categorized into 1) near-real-time RAN intelligent controller (Near-RT RIC) for automating functions that take between 10 milliseconds to one second to complete and 2) non-real-time RAN intelligent controller (Non-RT RIC) for automating functions >1 second. The architecture being described for example in O-RAN Working Group 3 Near-Real-time RAN Intelligent Controller Near-RT RIC Architecture (O-RAN WG3 RICARCH-v02.00).

Example applications for Near-RT-RIC (also referred to as xApps) are handover decisions, dual connectivity, predicting quality of experience (QoE) of a wireless communication device such as a smart phone, tablet, connected vehicle, etc., while example applications for Non-RT-RIC (also referred to as rApps) are orchestration, programmability and optimization. To execute control, an rApp and xApp sends a recommendation for action, e.g., updating operational parameters, changing an execution policy, deploying an updated model, etc.

The RAN performance is measured and indicated by RAN key performance indicators (KPIs). Example of KPIs include e.g., session setup success rate (SSSR), session abnormal release rate (SARR), handover success rate (HOSR), latency downlink (LAT_DL), downlink user throughput (DLUT) and minutes per abnormal release rate (MPAR) power consumption.

Applications (i.e. rApps and xApps in case of O-RAN) might have conflicting recommendations for actions. Now, although O-RAN is used as an example, any system executing applications which are at risk of conflicting with other applications may face this problem. Such conflicts reduce efficiency in overall operation (e.g., degrading KPIs), if they are not detected and resolved in a timely fashion.

### SUMMARY

An objective is to solve, or mitigate, this problem in the art and thus to provide a method of a device of detecting conflicts between applications being executed in an environment.

This objective is attained in a first aspect by a method of a device of detecting conflicts between applications being executed in an environment. The method comprises identifying a plurality of applications being executed in said environment, determining at least one performance property being affected by each of the identified applications being executed in said environment, determining whether or not at least two of the identified applications have a conflicting effect on the determined at least one performance property upon being executed in said environment, and if so determining whether or not a metric indicating degree of conflict between said at least two of the identified applications complies with a conflict severity criteria, and if so detecting a conflict between the at least two applications being executed in said environment.

This objective is attained in a second aspect by a device configured to detect conflicts between applications being executed in an environment, the device comprising a processing unit and a memory, said memory containing instructions executable by said processing unit, whereby the device is operative to identify a plurality of applications being executed in said environment, determine at least one performance property being affected by each of the identified applications being executed in said environment, determine whether or not at least two of the identified applications have a conflicting effect on the determined at least one performance property upon being executed in said environment, and if so to determine whether or not a metric indicating degree of conflict between said at least two of the identified applications complies with a conflict severity criteria, and if so to detect a conflict between the at least two applications being executed in said environment.

Thus, a performance property—also referred to as a key performance indicator (KPI)—is determined to be affected by a plurality of applications executing in a particular environment, such as in a radio access network. Thereafter, it is determined whether or not the applications have a conflicting effect on the KPI by evaluating whether or not a metric indicating degree of conflict may complies with a conflict severity criteria. If so, a conflict between the applications is advantageously detected, wherein e.g. an alert may be provided such that one or more of the applications may be deactivated or reconfigured.

In an embodiment, the metric indicating degree of conflict is considered to comply with the conflict severity criteria if a value of the metric exceeds a predetermined conflict severity criteria threshold value.

In an embodiment, the metric indicating degree of conflict being computed by evaluating impacts of said at least two of the identified applications on the determined at least one performance property and if a magnitude of negative impact is equal to or exceeds that of positive impact, the conflict severity criteria is considered to be complied with.

In an embodiment, the metric indicating degree of conflict is considered to comply with the conflict severity criteria if the conflicting effect persists over a set time period.

In an embodiment, an alert is provided indicating that a conflict is detected.

In an embodiment, one or more of said at least two of the identified applications are deactivated or reconfigured when a conflict is detected.

In an embodiment, the identifying of a plurality of applications being executed in an environment comprises identifying a plurality of applications being executed on multiple entities in a network, wherein the method further comprises creating associations between the applications determined to have a conflicting effect on the at least one performance property in a relation graph for each individual entity, aggregating the individual relation graphs to a common relation graph, wherein the determining whether or not a metric indicating degree of conflict between said at least two of the identified applications complies with a conflict severity criteria comprises assigning a weight to each overlapping association in the aggregated common relation graph, and determining whether or not the weight assigned to each overlapping association exceeds a conflict severity criteria threshold value.

In an embodiment, the identifying of a plurality of applications being executed in an environment comprises identifying a plurality of applications being executed on single entity at consecutive instants of time, wherein the method further comprises creating associations between the applications determined to have a conflicting effect on the at least one performance property in a relation graph for each instant of time, aggregating the individual relation graphs to a common relation graph, wherein the determining whether or not a metric indicating degree of conflict between said at least two of the identified applications complies with a conflict severity criteria comprises assigning a weight to each overlapping association in the aggregated common relation graph and determining whether or not the weight assigned to each overlapping association exceeds a conflict severity criteria threshold value.

In an embodiment, the environment in which conflicts are detected is an O-RAN, and said at least one performance property includes one or more of session setup success rate (SSSR), session abnormal release rate (SARR), handover success rate (HOSR), latency downlink (LAT_DL), downlink user throughput (DLUT), and minutes per abnormal release rate (MPAR) power consumption.

In a third aspect, a computer program comprising computer-executable instructions for causing a device to perform steps of the method of the first aspect when the computer-executable instructions are executed on a processing unit included in the device of the second aspect.

In a fourth aspect, a computer program product comprising a computer readable medium, the computer readable medium having the computer program according to the third aspect embodied thereon.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 illustrates a desktop configured to detect conflicts between locally executing applications according to an embodiment;

FIG. 2 shows a flowchart illustrating a method of detecting conflicts in an embodiment;

FIG. 3a shows a relation graph illustrating potentially conflicting applications according to an embodiment;

FIG. 3b shows a relation graph illustrating detected conflicting applications according to an embodiment;

FIG. 4 shows a communication network in which embodiments may be implemented;

FIG. 5 illustrates a simplified communication network in which embodiments may be implemented;

FIG. 6 shows a relation graph illustrating potentially conflicting applications among a plurality of base stations according to an embodiment;

FIG. 7 shows a flowchart illustrating a method of detecting conflicts in a further embodiment;

FIG. 8 shows an aggregated relation graph illustrating detecting conflicting applications among a plurality of base stations according to an embodiment;

FIG. 9 shows a relation graph illustrating potentially conflicting applications in a single base stations according to an embodiment; and

FIG. 10 illustrates a radio access network intelligent controller according to an embodiment.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

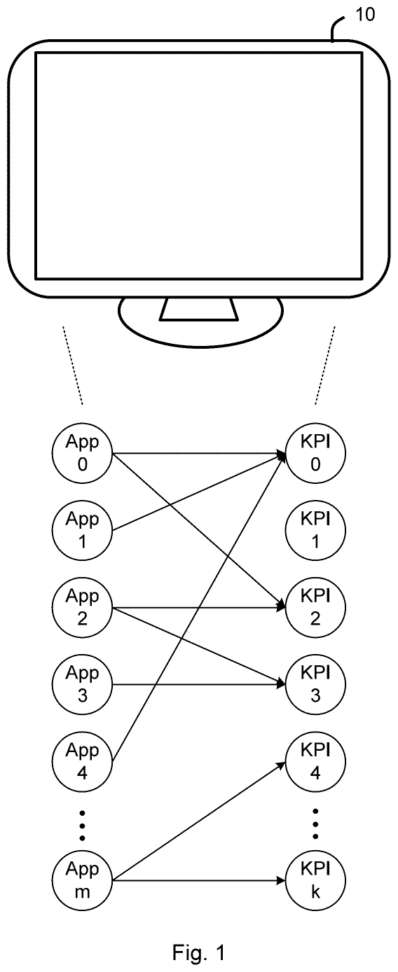

FIG. 1 illustrates an embodiment of detecting conflicts in an environment. While it previously has been discussed that conflicts are detected in a communication network such as O-RAN, in this particular example, a device such as a laptop or desktop computer, a smart phone, a tablet, a radio base station, etc., detects conflicts among applications executing locally in the device. In this example, the device is embodied in the form of a desktop computer 10. Hence, while the method may be performed in a relatively constrained environment such as locally in a computer, the environment in which conflicts are detected may be far more complex and extensive, such as a wireless communication system in the form of an O-RAN or a constrained subset of the system, as will be further discussed below.

Assuming that the m applications App0, App1, . . . , Appm are executing locally on the desktop 10. These applications may handle a variety of functions in the desktop 10, such as memory management, fan speed control, ethernet communication, etc.

In order to detect a conflict, each application is associated with one or more performance properties, in the following referred to as key performance indicators (KPIs), KPI0, KPI1, . . . , KPIk.

As an example, in FIG. 1, App0 is associated with both KPI0 and KPI2 while App1 is associated only with KPI0, App2 is associated with both KPI2 and KPI3, and so on.

To detect a conflict, the desktop 10 (or rather a processing unit of the desktop 10) will determine whether or not a KPI associated with two or more applications is negatively affected by such multi-app association.

For instance, assuming that KPI0 constitutes “load balancing” within the local environment of the desktop 10. Assuming further that a task of App0 is “memory management” and that a task of App1 is “processor core control”.

Hence, App0 will positively effect KPI0 in that writing to and reading from various memories in the desktop is controlled by App0 to attain an appropriate load balancing within the desktop 10, and App2 will also positively effect KPI0 in that controlling on which one(s) of multiple processors instructions are to be executed also attains an appropriate load balancing within the desktop.

Assuming in contrast that a task of App4 is “interrupt control” where dedicated functions will be given priority over other tasks and thus have App1 interrupt and override App0 and App2 upon being executed and as a result at least temporarily cause imbalance to the desktop load for performing the dedicated function, such as e.g. activating a plug-in with a keyboard being connected to a desktop port, and cause a sudden interrupt and hence negatively affect KPI0.

In another example, assuming that a task of App2 is “fan speed control” which affects KPI2 constituting “energy conservation”. The task of App2 may hence be to control speed of a desktop fan for cooling purpose, where the fan is controlled to optimize energy consumption of the fan. For instance, it may be beneficial to operate the fan at a relatively constant and even speed rather than sudden increases/decrease in fan speed.

As shown in FIG. 1, App0 also affects KPI2 and as an example, in case App0 for load balancing purposes would conclude that a large part of a random access memory (RAM) is to be utilized in favour of a hard disk memory, intensity of the data processing of the desktop 10 will likely increase, causing a higher energy consumption. As a consequence, APP0 will have a negative impact on KPI2.

As is understood, in practice tens or even hundreds of applications may execute in the desktop 10 and thus affect a great number of KPIs.

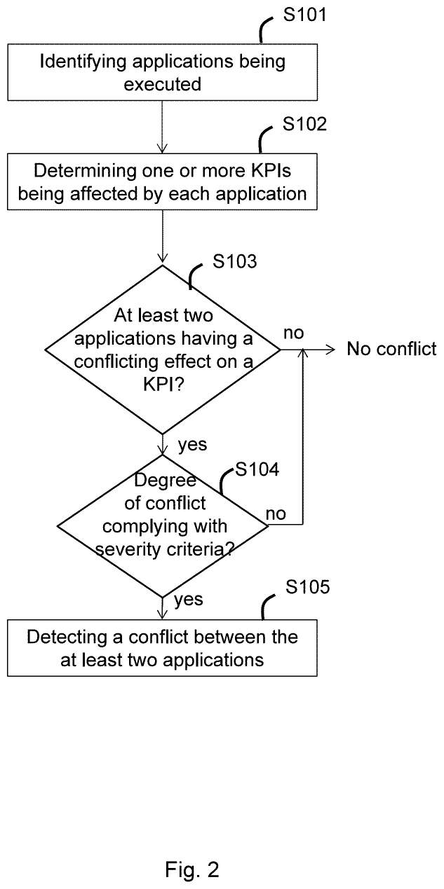

FIG. 2 shows a flowchart illustrating a method of detecting conflicts in an environment, in the context of the above given example of FIG. 1.

In a first step S101, the desktop 10 identifies a plurality of applications App0, App1, . . . , Appm being executed in the desktop 10.

Thereafter, the desktop 10 determines in step S102 at least one performance property, i.e. KPI, being affected by each of the identified applications being executed in the desktop.

As illustrated in FIG. 1, the desktop 10 may list a plurality of KPIs being particularly important to monitor, and thereafter determine whether or not one or more applications have an impact on each KPI. As shown in FIG. 1, none of the applications are considered to affect KPI1 and the desktop 10 may hence conclude already at this stage that there is no risk of conflict associated with KPI1.

As is understood, even if two or more applications affect a KPI, a conflict will not necessarily arise since each of the applications may have a positive effect on said KPI and as a result the two or more applications will not have a conflicting effect on the KPI.

Again with reference to FIG. 2, the desktop 10 will in step S103 determine whether or not at least two of the identified applications have a conflicting effect on a given KPI upon being executed.

In other words, in line with the previous example, the desktop 10 concludes in step S103 that while App0 and App1 (“memory management” and “processor core control”, respectively) have a positive effect on KPI0 (“load balancing”), App4 (“interrupt control”) will conversely have a negative effect on KPI0, and as a result the desktop 10 concludes in step S103 that there is a conflict between App0, App1 and App4.

Further in line with the previous example, the desktop 10 concludes in step S103 that while App2 (“fan speed control”) has a positive effect on KPI2 (“energy conservation”), App0 in contrast has a negative effect on KPI2, and as a result a the desktop 10 determines in step S103 that App0 and App2 have a conflicting effect on KPI2.

In this particular example, even though App2, App3 and Appm are considered to affect KPI3, they all have a positive impact on KPI3 and the desktop 10 will conclude in step S103 there is no conflict between App2, App3 and Appm.

An arithmetic measure may be introduced to determine the effect/impact of an application on a particular KPI as illustrated in Table 1 below, where “1” indicates a positive effect, “−1” indicates a negative effect and “0” indicates that an application does not affect a KPI:

TABLE 1
Arithmetic measures on application impact on KPIs.

| | KPI0 | KPI2 | KPI3 |
|---|---|---|---|
| App0 | 1 | −1 | 0 |
| App1 | 1 | 0 | 0 |
| App2 | 0 | 1 | 1 |
| App3 | 0 | 0 | 1 |
| App4 | −1 | 0 | 0 |
| Appm | 0 | 0 | 1 |

As is understood, while the arithmetic measure in this particular exemplifying example is represented by an integer, it may well be envisaged that the measure instead is expressed by means of a float number. Thus, in such case the measure may attain just about any value within a given range, say between −1 and +1.

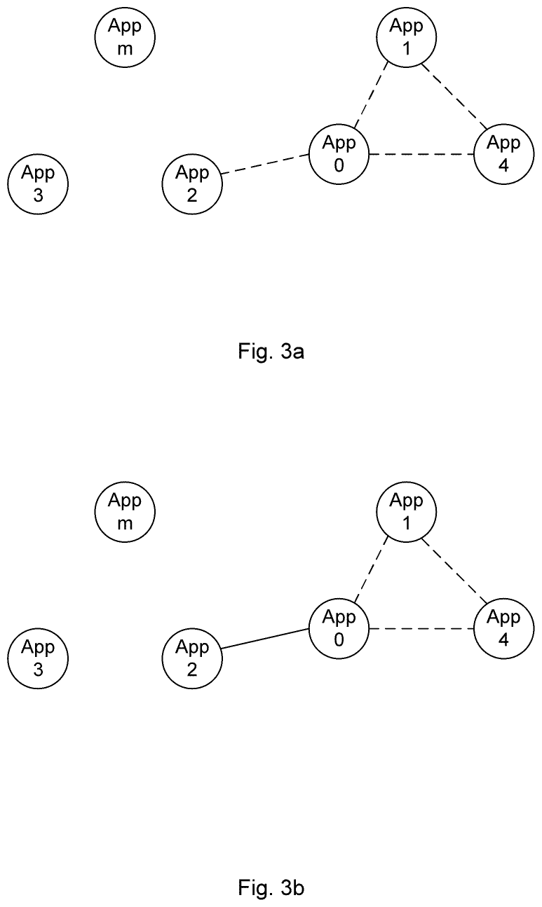

FIG. 3a shows a relation graph which may be created according to an embodiment to illustrate conflicting applications, to which reference further will be made.

As can be seen in FIG. 3a there is a potential conflict (as indicated with dotted lines connecting the applications) between:
App0, App1 and App4 due to the negative effect on KPI0, and
App0 and App2 due to the negative effect on KPI2, while
there is no conflict among App2, App3 and Appm since none of them affect KPI3 negatively.

Now, with reference to FIG. 2, after the desktop 10 has determined in S103 that there indeed is a conflict between App0, App1 and App4 on the one hand and App0 and App2 on the other, the desktop 10 determines a metric indicating degree of conflict between the at least two conflicting applications in step S104.

For instance, considering the conflict detected between App0 and App1 (“memory management” and “processor core control”, respectively) on the one hand and App4 (“interrupt control”) on the other in step S103; if the desktop 10 would consider this a minor conflict in step S104, the desktop 10 may determine that no conflict is detected.

To the contrary, should the desktop 10 determine in step S104 that the degree of conflict is substantial, then the desktop 10 indeed proceeds with detecting a conflict in step S105.

To this end, the desktop 10 will determine in step S104 whether or not the metric indicating degree of conflict between the at least two conflicting applications fulfils a conflict severity criteria.

Numerous options may be envisaged for determining an appropriate degree of conflict depending on the particular implementation, and some of these options will be discussed in the following.

In an embodiment, the desktop 10 may for two or more applications determined to have a conflicting effect on a given KPI in step 103 evaluate a metric indicating degree of conflict between the applications in the form of “duration of conflict”, wherein the metric is considered the fulfil the conflict severity criteria in step S104 only if the duration of the conflict between the application extends over a certain time period T—i.e. duration of conflict>T—in which case a conflict is indeed detected in step S105.

In another embodiment, the desktop 10 may sum the impact measures of Table 1 for each KPI to which a conflicting effect is caused and determine that the conflict severity criteria is complied with only if the sum of impact measure for a given KPI is below 1.

Thus, turning to Table 1, for KPI0 the sum of the impact measures is 1+1−1=1 while for KPI2 the sum of the impact measures is 1−1=0.

In this particular example, the degree of conflict for App0, App1 and App4 is not considered to comply with the conflict severity criteria, the rationale being that two of the applications have a positive effect while only one has a negative effect on KPI0.

On the other hand, the degree of conflict for App0 and App2 is indeed considered to comply with the conflict severity criteria, the rationale being that one of the applications have a positive effect while one has a negative effect; if a magnitude of negative impact is equal to or exceeds that of positive impact, the conflict severity criteria is considered to be complied with.

Alternatively, the desktop 10 may conclude that even if App0 has a negative impact while App2 has a positive impact on KPI2, the desktop 10 may conclude that App0 does not have a sufficiently great negative impact (e.g. exceeding a conflict severity criteria threshold value), and therefore no conflict is detected in step S105.

In practice, where tens or even hundreds of applications may affect a given KPI negatively, the conflict severity criteria is more likely to be complied with the higher the number of applications affecting the KPI negatively.

FIG. 3b illustrates the relation graph of FIG. 3a with the further addition of a continuous line indicating a detected conflict. In the relation graph, the continuous line is hence given a higher weight than the dotted lines to indicate a detected conflict. Thus, while conflicting effects caused by App0, App1 and App4 to KPI0 indeed was determined in step S103 (as indicated with dotted lines), only the conflicting effect caused by App0 and App2 to KPI2 was considered to comply with the conflict severity criteria in step S104, which subsequently resulted in conflict detection in step 105.

As a result, the desktop may conclude that any one or both of App0 and App2 e.g. should be temporarily deactivated, while the conflicts App0-App1, App0-App4 and App1-App4 are not considered to satisfy the set conflict severity criteria and will not be detected as such. Advantageously, only conflicts being considered sufficiently severe will indeed be detected as conflicts for which an alert is to be provided.

As a further example, considering the above-discussed “duration of conflict” selected as a metric indicating degree of conflict between the applications; if a user swiftly plugs in a keyboard thereby causing a brief interrupt, then the conflict severity criteria may not be complied with in step S104 and no conflict is detected.

If on the other hand the user repeatedly connects and disconnects the keyboard causing repeated interrupts, then the conflict severity criteria may be considered to be complied with in step S104 due to the extended duration of the conflict and a conflict is indeed detected in step S105.

In embodiments, the desktop 10 may after having detected a conflict between two or more applications in step S105 determine e.g. that one or more of the conflicting applications are to be temporarily deactivated, or provide an alert to an operating system executing on the desktop 10 that a conflict has been detected in order for the operating system to take an appropriate action.

As mentioned, the approach may also be expanded to determine conflicting applications executing on a communications network, such as a client-server network where a server device detects conflicting applications executing on plurality of client devices in the network, and also in a wireless communications network implementing an appropriate radio access technology (RAT), such as 2G, 3G, 4G and 5G technologies—e.g. Global System for Mobile Communications (GSM), Universal Mobile Telecommunications System (UMTS), Long Term Evolution (LTE) and New Radio (NR), respectively.

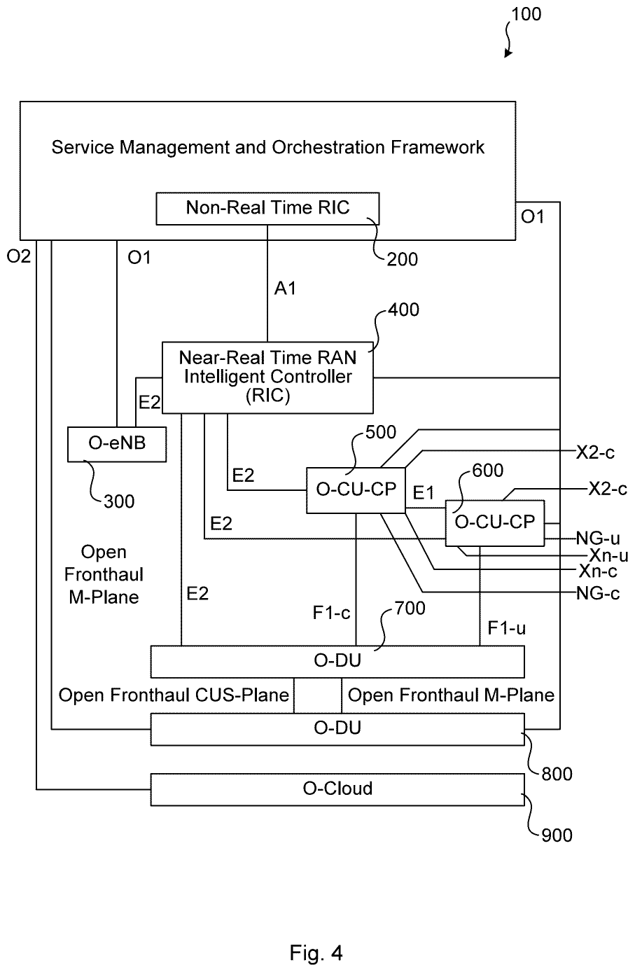

For example, the method may be implemented in a RIC of an O-RAN 100 as briefly illustrated in FIG. 4. The role of a Non-RT RIC 200 is among other things such as providing a service management and orchestration framework to serve one or more radio base stations 300 referred to as O-eNB via O1 interface and to provide high-level control signals to Near-RT RICs 400 via A1 interface; such signals include but not limited to policy-based guidance, ML model management, and enrichment of data. The role of Near-RT RICs 400 is to perform low-level control signals to O-RAN compatible network elements including the one or more O-eNBs 300, O-CU-CP 500 (“central unit control plane”), O-CU-UP 600 (“central unit use plane”) and O-DU 700 (“distributed unit”) via E2 interface. Further included is an O-RU 800 (“radio unit”) connected to the O-DU 700 via a control, user and synchronization (CUS) plane as well as via a management (M) plane, and an O-cloud 900, i.e. a cloud platform.

As previously mentioned, rApps executing on the Non-RT RIC 200 and xApps executing on the Near-RT RICs 400 may provide conflicting recommendations for actions. That is, like in the embodiments described hereinabove, rApps and xApps executing in the O-RAN 100 may have conflicting effects on one or more KPIs. As previously mentioned, KPIs in this particular context may include e.g., session setup success rate (SSSR), session abnormal release rate (SARR), handover success rate (HOSR), latency downlink (LAT_DL), downlink user throughput (DLUT) and minutes per abnormal release rate (MPAR) power consumption.

In an example, a conflict may arise between a first application providing mobility load balancing while a second application provides mobility robustness optimization, which is common in self-organizing networks. Such a conflict typically results in a user being moved back-and-forth from one cell to another, which leads to the user being ping-ponged between the two cells and thus reduced operation efficiency.

In another example, ML models are applied for optimizing QoE for various services in the same RAN. In such a use case, an ML model typically exists for each service (e.g., cloud virtual reality and video streaming) and/or function (e.g. optimizing spectrum efficiency and energy efficiency), and conflicts occur since the ML models are optimized for different goals.

The number of applications executing in a single base station is numerous; in practice, it may amount to 100+ applications. Further, the applications are diverse in the sense that they are developed for a wide range of purposes and use cases, which is even further complicated by the fact that the applications may be multivendor in line with the open development nature of O-RAN. This may cause even further conflicts upon the various multivendor applications being deployed in a network.

In an exemplifying embodiment described in the following, the Non-RT RIC 200 will detect conflicting applications executing on a number of Near-RT RICs.

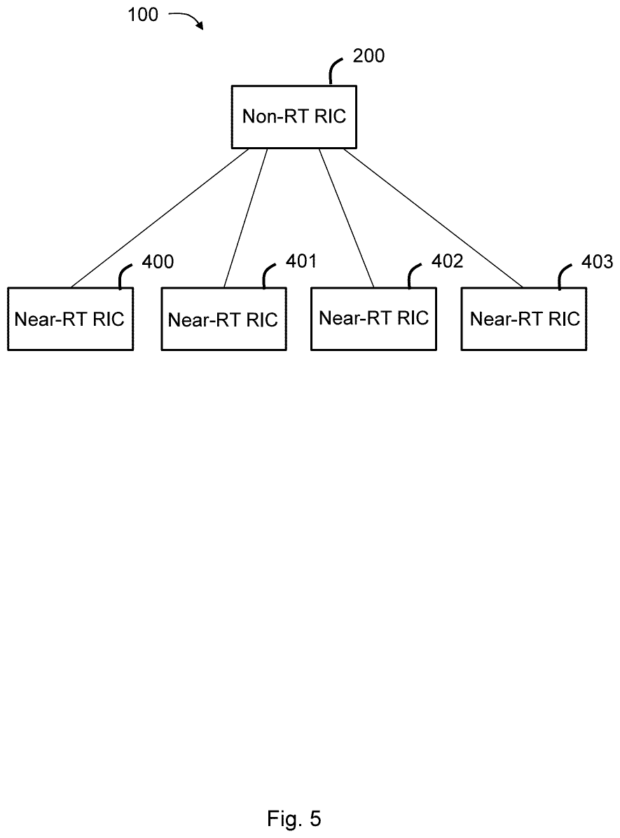

It is noted that FIG. 5 illustrates a much simplified O-RAN system as compared to that in FIG. 4, only showing the Non-RT RIC 200 and four Near-RT RICs 400-403.

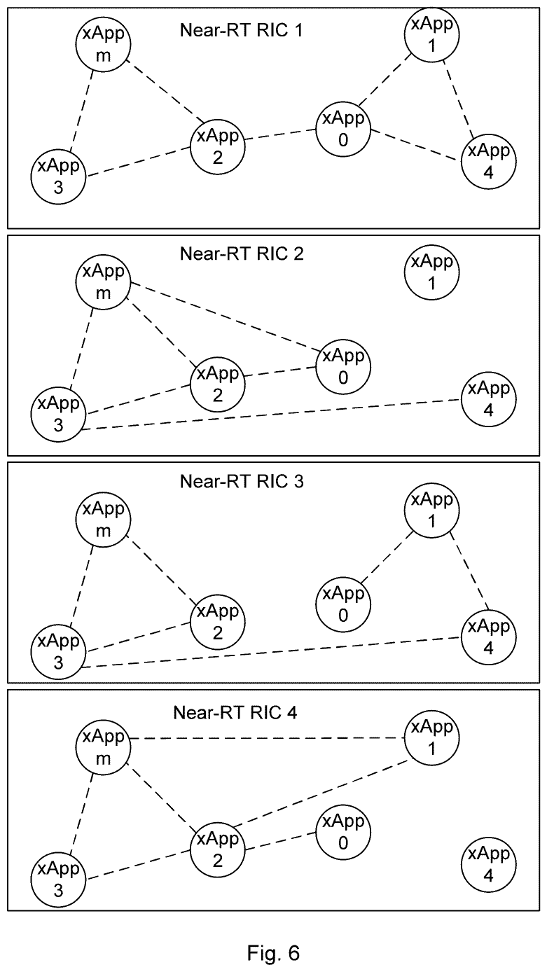

FIG. 6 illustrates that each Near-RT RICs executes the same applications xApp0, xApp1, . . . , xAppm and shows relation graphs being created by the Non-RT RIC 200 illustrating potentially conflicting applications at each individual Near-RT RICs as will be described in more detail below. As is understood, in this embodiment providing a different technical context than that of FIG. 1, the applications would typically provide a different functionality than the functionality of those illustrated with reference to FIG. 1, examples of which having been discussed hereinabove.

In FIG. 6, it can be seen that on first Near-RT RIC 400 and third Near-RT RIC 402, each application has a potential conflict with at least one other application, while on second Near-RT RIC 401 xApp1 has no potential conflicts with any of the other applications, and on fourth Near-RT RIC 403 xApp4 has no potential conflicts with any of the other applications.

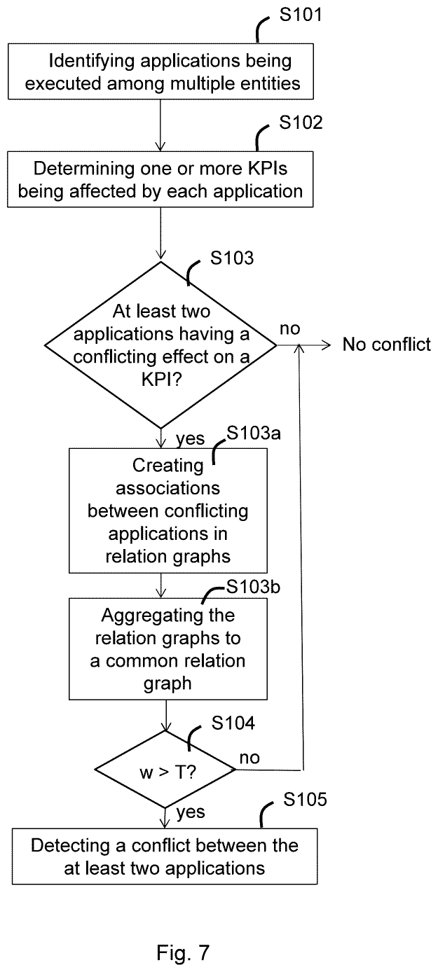

With reference to the flowchart of FIG. 7, in this embodiment (similar to previous embodiment with reference to the flowchart of FIG. 2) the Non-RT RIC 200 will identify applications being executed on each Near-RT RIC in step S101 and also in step S102 determine KPIs being affected by the identified applications, and further determine in step S103 whether or not at least two applications have a conflicting effect on a given KPI.

In a communications network such as that illustrated in FIG. 6, network operators typically have access to information regarding which applications potentially may cause conflicts, e.g., in terms of power allocation and resource allocation, and also KPIs that are affected (and how the KPIs are affected). The network operator also has information on which Near-RT RIC the identified application are executing, and this information may be provided to the Non-RT RIC 200 by the network operator.

Alternatively, each Near-RT RIC may provide the Non-RT RIC 200 with information regarding which applications are executed, KPIs being affected, and further whether or not there are conflicting applications executing on said each Near-RT RIC taking into account the affected KPIs.

In this embodiment, the Non-RT RIC 200 will in step S103a further associate conflicting applications with each other in a relation graph as illustrated in FIG. 6 for each individual Near-RT RIC. Thus, taking the first Near-RT RIC 400 as an example, the Non-RT RIC 200 determines in step S103 that there is a conflict between xApp1 and xApp4 and thus forms an association between the two in step S103a in the form of the dotted line, the Non-RT RIC 200 determines in that there is a conflict between xApp0 and xApp1 and thus forms an association between the two, and so on.

Thus, whether or not two or more identified applications have a conflicting effect on a KPI is determined on an individual basis, i.e. for each individual Near-RT RIC as illustrated in FIG. 6.

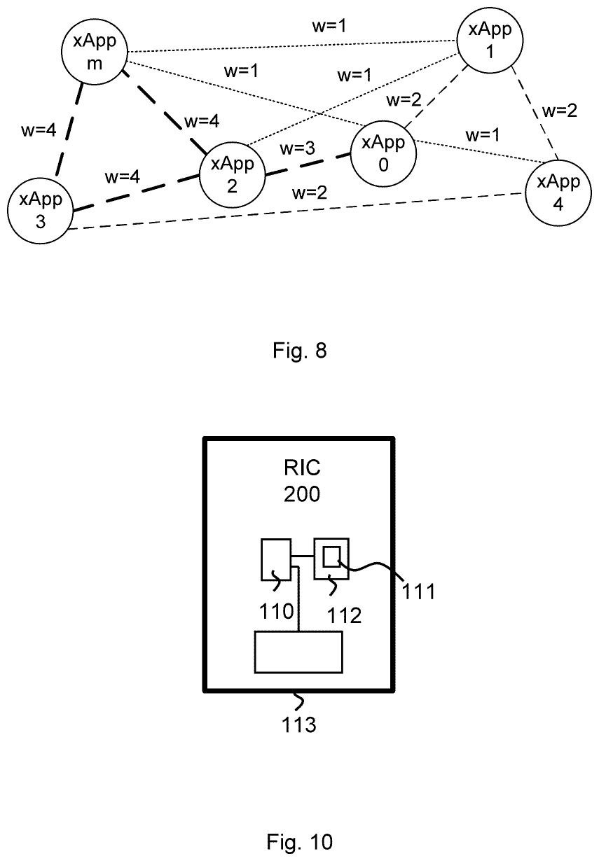

Thereafter, the Non-RT RIC 200 will take a collective decision by aggregating in step S103b all individual relation graphs to a common graph as shown in FIG. 8 in order to determine in step S104 whether or not a metric indicating degree of conflict between conflicting applications fulfils a conflict severity criteria.

In this particular example, the metric is embodied by the number of overlaps for each created association in the aggregated relation graph. In other words, a weight w is given to each association—i.e. to each pair of conflicting applications—and if a conflict between two given applications is present on multiple Near-RT RICs, that particular conflict will be given a higher weight and will thus be considered more severe than a conflict being present on a fewer number of Near-RT RICs.

As illustrated in the individual relation graphs of FIG. 6, a conflict between application xApp2 and each of xApp3 and xAppm and between xApp3 and xAppm is found in all four Near-RT RIC, while a conflict between applications xApp0 and xApp2 is found in first Near-RT RIC 400, second Near-RT RIC 401 and fourth Near-RT RIC 403, a conflict between applications xApp3 and xApp4 is found in second Near-RT RIC 401 and third Near-RT RIC 402, and so on, as illustrated in Table 2 below.

TABLE 2
Number of identified conflicts between each pair of applications.

| | xApp0 | xApp1 | xApp2 | xApp3 | xApp4 | xAppm |
|---|---|---|---|---|---|---|
| xApp0 | — | 2 | 3 | 0 | 1 | 1 |
| xApp1 | 2 | — | 1 | 0 | 2 | 1 |
| xApp2 | 3 | 1 | — | 4 | 0 | 4 |
| xApp3 | 0 | 0 | 4 | — | 2 | 4 |
| xApp4 | 1 | 2 | 0 | 2 | — | 0 |
| xAppm | 1 | 1 | 4 | 4 | 0 | — |

Thus, the Non-RT RIC 200 may in one embodiment conclude that a conflict finally only is detected in step S105 between a set of applications if that particular conflict is found on a sufficient high number of Near-RT RICs in step S104.

With reference to the aggregated relation graph of FIG. 8, based on the number of overlaps set out in Table 2, a weight is associated with each conflict, where e.g. the conflict must be identified on at least three Near-RT RICs in order to be detected as a conflict, i.e. in this case the conflict between applications xApp2, xApp3 and xAppm and the conflict between applications xApp0 and xApp2. In other words, the conflict severity criteria is satisfied in step S104 for aggregated weight w>T, where T=2. Of course, any appropriate weight may be set by the Non-RT RIC 200 as a conflict severity criteria threshold.

Thereafter, an appropriate action is taken such as providing an alert and/or deactivating or reconfiguring one or more conflicting applications.

Thus, in the embodiment illustrated in FIG. 6, even though there may be conflicting applications at each individual Near-RT RIC, the decision as to whether or not a conflict is detected is taken at a collective level, where the conflicts at each individual Near-RT RIC is aggregated such that a common decision may be taken by the Non-RT RIC 200, the rationale in this example being that a conflict between applications only will be considered sufficiently severe if the conflict is present on a sufficient high number of Near-RT RICs. If not, the KPI being negatively affected by the conflict is simply not considered to be affected to a sufficiently high degree (e.g. for an alert to be provided, or one or more applications to be deactivate).

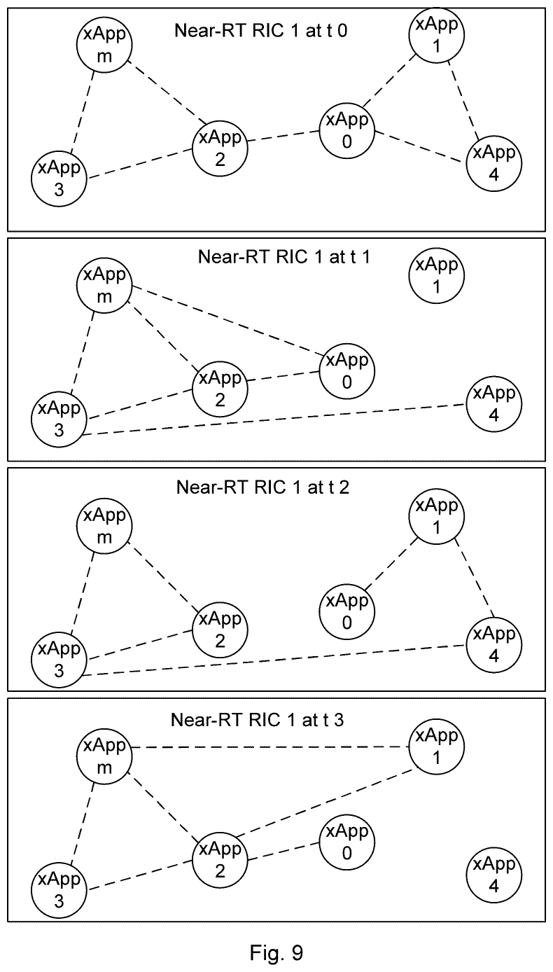

As illustrated in FIG. 9, in another scenario, rather than taking account applications being executed on a plurality of Near-RT RICs 400-403 as illustrated in FIG. 6, it may be envisaged that application executing on a single Near-RT RIC over a time period.

As is understood, the aggregate of the relation graphs of FIG. 9 would have the same appearance as that illustrated in FIG. 8, but that conclusion by the Non-RT RIC 200 would be that conflicts persisting over time, such as at four consecutive instants t0, t1, t2 and t3, indeed will be detected as conflicts. Thus, in this example, for associations having a weight of 4, a conflict will be detected. Again, the Non-RT RIC 200 may select any appropriate value on the weight w as conflict severity criteria threshold, and the time period may be selected depending on particular implementation, such as seconds, minutes, hours or even days.

FIG. 10 illustrates a device exemplified in the form of a Non-RT RIC 200 configured to detect conflicts between applications according to an embodiment. The steps of the method performed by the Non-RT RIC 200 are in practice performed by a processing unit 110 embodied in the form of one or more microprocessors arranged to execute a computer program 111 downloaded to a suitable storage volatile medium 112 associated with the microprocessor, such as a Random Access Memory (RAM), or a non-volatile storage medium such as a Flash memory or a hard disk drive. The processing unit 110 is arranged to cause the Non-RT RIC 200 to carry out the method according to embodiments described herein, when the appropriate computer program 111 comprising computer-executable instructions is downloaded to the storage medium 112 and executed by the processing unit 110. The storage medium 112 may also be a computer program product comprising the computer program 111. Alternatively, the computer program 111 may be transferred to the storage medium 112 by means of a suitable computer program product, such as a Digital Versatile Disc (DVD) or a memory stick. As a further alternative, the computer program 111 may be downloaded to the storage medium 112 over a network. The processing unit 110 may alternatively be embodied in the form of a digital signal processor (DSP), an application specific integrated circuit (ASIC), a field-programmable gate array (FPGA), a complex programmable logic device (CPLD), etc. The Non-RT RIC 200 further comprises an interface 113 over which data may be received and transmitted.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of a device of detecting conflicts between applications being executed in an environment, comprising:
identifying a plurality of applications being executed in said environment;
determining at least one performance property being affected by each of the identified applications being executed in said environment;
determining whether or not at least two of the identified applications have a conflicting effect on the determined at least one performance property upon being executed in said environment; and if so:
determining whether or not a metric indicating degree of conflict between said at least two of the identified applications complies with a conflict severity criteria; and if so:
detecting a conflict between the at least two applications being executed in said environment.

2. The method of claim 1, wherein the metric indicating degree of conflict is considered to comply with the conflict severity criteria if a value of the metric exceeds a predetermined conflict severity criteria threshold value.

3. The method of claim 1, the metric indicating degree of conflict being computed by evaluating impacts of said at least two of the identified applications on the determined at least one performance property and if a magnitude of negative impact is equal to or exceeds that of positive impact, the conflict severity criteria is considered to be complied with.

4. The method of claim 1, wherein the metric indicating degree of conflict is considered to comply with the conflict severity criteria if the conflicting effect persists over a set time period.

5. The method of claim 1, further comprising:
providing an alert indicating that a conflict is detected.

6. The method of claim 1, further comprising:
deactivating or reconfiguring one or more of said at least two of the identified applications when a conflict is detected.

7. The method of claim 1, wherein the identifying of a plurality of applications being executed in an environment comprises identifying a plurality of applications being executed on multiple entities in a network, further comprising:
creating associations between the applications determined to have a conflicting effect on the at least one performance property in a relation graph for each individual entity;
aggregating the individual relation graphs to a common relation graph; wherein the determining whether or not a metric indicating degree of conflict between said at least two of the identified applications complies with a conflict severity criteria comprises:
assigning a weight to each overlapping association in the aggregated common relation graph; and
determining whether or not the weight assigned to each overlapping association exceeds a conflict severity criteria threshold value.

8. The method of claim 1, wherein the identifying of a plurality of applications being executed in an environment comprises identifying a plurality of applications being executed on single entity at consecutive instants of time, further comprising:
creating associations between the applications determined to have a conflicting effect on the at least one performance property in a relation graph for each instant of time;
aggregating the individual relation graphs to a common relation graph; wherein the determining whether or not a metric indicating degree of conflict between said at least two of the identified applications complies with a conflict severity criteria comprises:
assigning a weight to each overlapping association in the aggregated common relation graph and
determining whether or not the weight assigned to each overlapping association exceeds a conflict severity criteria threshold value.

9. The method of claim 1, the environment being an Open Radio Access Network, O-RAN, and said at least one performance property includes one or more of session setup success rate, SSSR, session abnormal release rate, SARR, handover success rate, HOSR, latency downlink, LAT_DL, downlink user throughput, DLUT, and minutes per abnormal release rate, MPAR, power consumption.

10. A computer program comprising computer-executable instructions for causing a device to perform steps recited in claim 1 when the computer-executable instructions are executed on a processing unit included in the device.

11. A computer program product comprising a computer readable medium, the computer readable medium having the computer program according to claim 10 embodied thereon.

12. A device configured to detect conflicts between applications being executed in an environment, the device comprising a processing unit and a memory, said memory containing instructions executable by said processing unit, whereby the device is operative to:
identify a plurality of applications being executed in said environment;
determine at least one performance property being affected by each of the identified applications being executed in said environment;
determine whether or not at least two of the identified applications have a conflicting effect on the determined at least one performance property upon being executed in said environment; and if so to:
determine whether or not a metric indicating degree of conflict between said at least two of the identified applications complies with a conflict severity criteria; and if so to:
detect a conflict between the at least two applications being executed in said environment.

13. The device of claim 12, further being operative to consider the metric indicating degree of conflict to comply with the conflict severity criteria if a value of the metric exceeds a predetermined conflict severity criteria threshold value.

14. The device of claim 12, further being operative to compute the metric indicating degree of conflict by evaluating impacts of said at least two of the identified applications on the determined at least one performance property and if a magnitude of negative impact is equal to or exceeds that of positive impact, the conflict severity criteria is considered to be complied with.

15. The device of claim 12, further being operative to consider the metric indicating degree of conflict to comply with the conflict seventy criteria if the conflicting effect persists over a set time period.

16. The device of claim 12, further being operative to:
provide an alert indicating that a conflict is detected.

17. The device of claim 12, further being operative to: deactivate or reconfigure one or more of said at least two of the identified applications when a conflict is detected.

18. The device of claim 12, further being operative to identify a plurality of applications being executed on multiple entities in a network when identifying a plurality of applications being executed in an environment, and further being operative to:
create associations between the applications determined to have a conflicting effect on the at least one performance property in a relation graph for each individual entity;
aggregate the individual relation graphs to a common relation graph; wherein the determining whether or not a metric indicating degree of conflict between said at least two of the identified applications complies with a conflict severity criteria comprises to:
assign a weight to each overlapping association in the aggregated common relation graph; and to
determine whether or not the weight assigned to each overlapping association exceeds a conflict severity criteria threshold value.

19. The device of claim 12, further being operative to identify a plurality of applications being executed on single entity at consecutive instants of time when identifying a plurality of applications being executed in an environment, and further being operative to:
create associations between the applications determined to have a conflicting effect on the at least one performance property in a relation graph for each instant of time;
aggregate the individual relation graphs to a common relation graph; wherein the determining whether or not a metric indicating degree of conflict between said at least two of the identified applications complies with a conflict severity criteria comprises to:
assign a weight to each overlapping association in the aggregated common relation graph and to
determine whether or not the weight assigned to each overlapping association exceeds a conflict severity criteria threshold value.

20. The device of claim 12, the environment being an Open Radio Access Network, O-RAN, and said at least one performance property includes one or more of: session setup success rate, SSSR, session abnormal release rate, SARR, handover success rate, HOSR, latency downlink, LAT_DL, downlink user throughput, DLUT, and minutes per abnormal release rate, MPAR, power consumption.
